(19) United States
(12) Patent Application Publication
(10) Pub. No.: US 2024/0219769 A1
(43) Pub. Date: Jul. 4, 2024

(54) DISPLAY DEVICE

(71) Applicant: Xiamen Tianma Micro-Electronics Co., Ltd., Xiamen (CN)

(72) Inventors: Yan YANG, Xiamen (CN); Yahua ZHANG, Xiamen (CN); Qiong SONG, Xiamen (CN); Caijiao ZHONG, Xiamen (CN); Junyi LI, Xiamen (CN)

(21) Appl. No.: 18/127,256

(22) Filed: Mar. 28, 2023

(30) Foreign Application Priority Data
Dec. 30, 2022 (CN) 202211731312.0

(51) Int. Cl. G02F 1/1335; F21V 8/00; G02F 1/13357; G02F 1/1347

(52) U.S. Cl. CPC G02F 1/133601; G02B 6/0056; G02F 1/133531; G02F 1/133603; G02F 1/13362; G02F 1/1347; G02F 1/133514; G02F 1/134309; G02F 2203/48

(57) ABSTRACT

A display device is provided. The display device includes a display component and a dimming component. The dimming component is disposed on a non-display side of the display component, and provides backlight for the display component. The dimming component includes a plurality of dimming regions, and light emitted from different dimming regions of the plurality of dimming regions is adjusted independently. One of the display component and the dimming component includes a first liquid crystal panel. The first liquid crystal panel includes a first polarizer and a second polarizer that are oppositely disposed, and first liquid crystal molecules located between the first polarizer and the second polarizer. A polarization direction of the first polarizer is perpendicular to a polarization direction of the second polarizer, and when the display device is not powered on, the first liquid crystal molecules are aligned at 45°.

### CROSS-REFERENCE TO RELATED APPLICATION

This application claims the priority of Chinese patent application No. 202211731312.0, filed on Dec. 30, 2022, the entirety of which is incorporated herein by reference.

### FIELD

The present disclosure generally relates to the field of display technology and, more particularly, relates to a display device.

### BACKGROUND

With the development of display technology, display devices have become more commonly applied, and have gradually become an indispensable part of people's daily work and life. The existing display devices include a liquid crystal display device and an organic light-emitting diode (OLED) display device. Because the liquid crystal display device has a substantially high contrast ratio, the liquid crystal display device has been rapidly developed and widely applied.

However, the maximum light transmittance of the existing liquid crystal display device needs to be improved, and the contrast ratio is also a very important parameter for the liquid crystal display device. Therefore, how to provide a display device with a substantially high light transmittance and a substantially high contrast ratio is an urgent technical problem that needs to be solved.

### SUMMARY

One aspect of the present disclosure provides a display device. The display device includes a display component and a dimming component. The dimming component is disposed on a non-display side of the display component, and provides backlight for the display component. The dimming component includes a plurality of dimming regions, and light emitted from different dimming regions of the plurality of dimming regions is adjusted independently. One of the display component and the dimming component includes a first liquid crystal panel. The first liquid crystal panel includes a first polarizer and a second polarizer that are oppositely disposed, and first liquid crystal molecules located between the first polarizer and the second polarizer. A polarization direction of the first polarizer is perpendicular to a polarization direction of the second polarizer, and when the display device is not powered on, the first liquid crystal molecules are aligned at 45°.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic diagram of an exemplary display panel consistent with disclosed embodiments of the present disclosure;

FIG. 2 illustrates a schematic diagram of a first liquid crystal panel of an exemplary display panel consistent with disclosed embodiments of the present disclosure;

FIG. 3 illustrates a schematic diagram of a relationship between a polarization direction of a first polarizer, a polarization direction of a second polarizer, and an alignment direction of first liquid crystal molecules of an exemplary display device consistent with disclosed embodiments of the present disclosure;

FIG. 4 illustrates a schematic diagram of a first liquid crystal panel of another exemplary display panel consistent with disclosed embodiments of the present disclosure;

FIG. 5 illustrates a schematic diagram of a first liquid crystal panel of another exemplary display panel consistent with disclosed embodiments of the present disclosure;

FIG. 6 illustrates a schematic diagram of a light source in an exemplary display panel consistent with disclosed embodiments of the present disclosure;

FIG. 7 illustrates a schematic diagram of a corresponding relationship between a dimming region and a pixel region of an exemplary display panel consistent with disclosed embodiments of the present disclosure;

FIG. 8 illustrates a schematic diagram of a light source in another exemplary display panel consistent with disclosed embodiments of the present disclosure;

FIG. 9 illustrates a schematic diagram of a corresponding relationship between a dimming region and a pixel region of another exemplary display panel consistent with disclosed embodiments of the present disclosure;

FIG. 10 illustrates a schematic diagram of a first liquid crystal panel of another exemplary display panel consistent with disclosed embodiments of the present disclosure;

FIG. 11 illustrates a schematic diagram of an exemplary display panel with a dimming component including a second liquid crystal panel consistent with disclosed embodiments of the present disclosure;

FIG. 12 illustrates a schematic diagram of another exemplary display panel with a dimming component including a second liquid crystal panel consistent with disclosed embodiments of the present disclosure;

FIG. 13 illustrates a schematic diagram of an exemplary display panel with a display component including a second liquid crystal panel consistent with disclosed embodiments of the present disclosure;

FIG. 14 illustrates a schematic diagram of another exemplary display panel with a display component including a second liquid crystal panel consistent with disclosed embodiments of the present disclosure;

FIG. 15 illustrates a schematic diagram of another exemplary display panel with a display component including a second liquid crystal panel consistent with disclosed embodiments of the present disclosure;

FIG. 16 illustrates a schematic diagram of another exemplary display panel with a display component including a second liquid crystal panel consistent with disclosed embodiments of the present disclosure;

FIG. 17 illustrates a schematic diagram of another exemplary display panel with a display component including a second liquid crystal panel consistent with disclosed embodiments of the present disclosure;

FIG. 18 illustrates a schematic diagram of a first liquid crystal panel of another exemplary display panel consistent with disclosed embodiments of the present disclosure; and

FIG. 19 illustrates a schematic diagram of a second liquid crystal panel of an exemplary display panel consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

The existing display device includes a liquid crystal display panel and a backlight module. When the liquid crystal display panel is not powered on, an angle between an alignment direction of the liquid crystal molecules and a polarization direction of a polarizer is 0° or 90°, such that the light transmittance is zero. When the liquid crystal display panel is powered on, the liquid crystal molecules are deflected. When the voltage on the liquid crystal display panel is applied to 5V, the light transmittance of the liquid crystal display panel reaches the maximum. In other words, only when the liquid crystal display panel is powered on and the voltage is applied to 5V, the light transmittance can reach the maximum value that the liquid crystal display panel can achieve. In other words, the existing display device is in a high-brightness state when being powered on and is in a dark state when not being powered on, and the power consumption in the high-brightness state is substantially high. Moreover, the light transmittance of the display device in the high-brightness state is 4.74%, which needs to be improved.

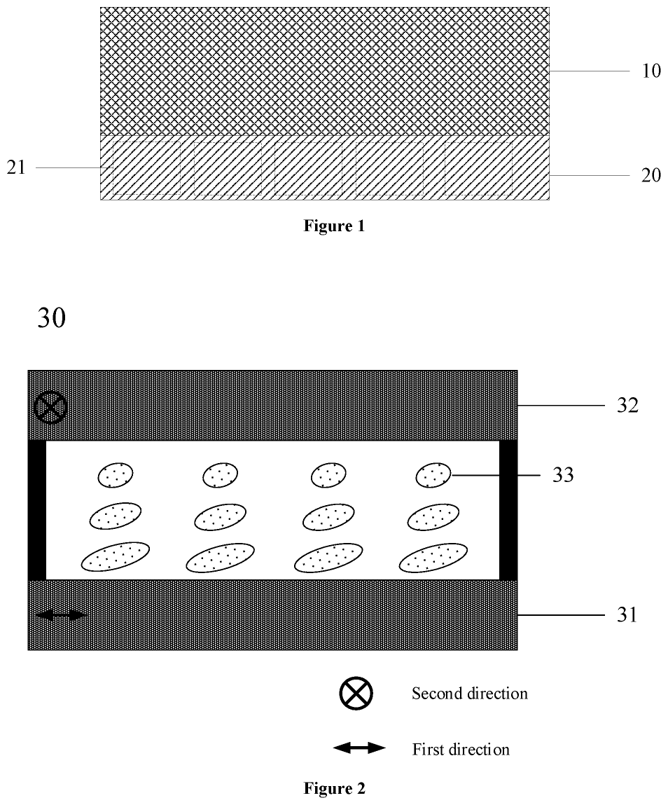

The present disclosure provides a display device. Referring to FIG. 1, the display device may include a display component 10 and a dimming component 20. The dimming component 20 may be disposed on a non-display side of the display component 10, and may provide backlight for the display component 10. The dimming component 20 may include a plurality of dimming regions 21, and the light emitted from different dimming regions 21 may be adjusted independently.

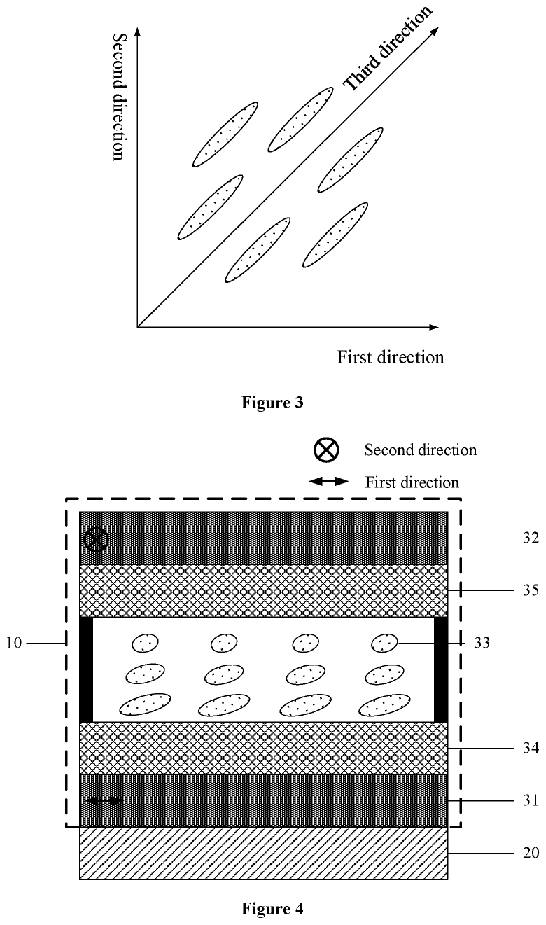

Referring to FIG. 2, the display component 10 or the dimming component 20 may include a first liquid crystal panel 30. The first liquid crystal panel 30 may include a first polarizer 31 and a second polarizer 32 that are oppositely disposed, and first liquid crystal molecules 33 disposed between the first polarizer 31 and the second polarizer 32. A polarization direction of the first polarizer 31 and a polarization direction of the second polarizer 32 may be perpendicular to each other, and may refer to a first direction and a second direction, respectively. Both the first direction and the second direction may be parallel to a film layer where each of the first polarizer 31, the second polarizer 32 and the liquid crystal molecules 33 are located. When the display device is not powered on, the first liquid crystal molecules 33 may be aligned at 45°. It should be noted that in one embodiment, when the display device is not powered on, the first liquid crystal molecules 33 may be aligned at 45°, in other words, the first liquid crystal molecules 33 may be aligned at 135°.

In one embodiment, the first liquid crystal panel may include the first polarizer, the second polarizer, and the first liquid crystal molecules disposed between the first polarizer and the second polarizer. The polarization direction of the first polarizer may be perpendicular to the polarization direction of the second polarizer, and the first liquid crystal molecules may be aligned at 45° when the display device is not powered on. It should be noted that when the disclosed display device is not powered on, in other words, in the initial alignment state of the liquid crystal molecules, the first liquid crystal molecules of the first liquid crystal panel may be aligned at 45°, which may be the maximum polarization angle of the matched first polarizer and second polarizer. When the display device is in operation, the light irradiated on the first liquid crystal molecules through the lower polarizer may be sufficiently rotated to the upper polarizer through the first liquid crystal molecules. Therefore, when the display device is not powered on, the light transmittance of the first liquid crystal panel may reach the maximum value.

When the display device is not powered on, the light transmittance of the first liquid crystal panel may reach the maximum value. Therefore, when the display device is not powered on, in other words, when the voltage is zero, the light transmittance of the display device may reach the maximum value. Therefore, the display device may be in a high-brightness state when the display device is not powered on, such that the power consumption of the display device in the high-brightness state may be substantially low, which may greatly reduce the power consumption of the display device in the high-brightness state.

Further, when the display device is not powered on, the light transmittance of the first liquid crystal panel may reach 5.37%. In other words, the light transmittance of the display device may reach 5.37% when the display device is in the high-brightness state. Compared with the existing display device, the light transmittance of the display device in the disclosed embodiments may be greater when being in the high-brightness state.

In addition, the display device may include the dimming component, and the light emitted from different dimming regions of the dimming component may be adjusted independently. By adjusting the amount of light emitted from different dimming regions of the dimming component, the brightness of the light irradiated on the display component may be adjusted to improve the contrast ratio of the display component, such that the contrast ratio of the display device may be substantially desired.

Therefore, the display device in the disclosed embodiments may have substantially low power consumption, substantially high light transmittance, and substantially desired contrast ratio when being in the high-brightness state.

It should be noted that the above-mentioned lower polarizer may be a polarizer among the first polarizer and the second polarizer disposed on a light-incident side of the first liquid crystal molecules, and the upper polarizer may be a polarizer among the first polarizer and the second polarizer disposed on a light-emitting side of the first liquid crystal molecules.

FIG. 3 illustrates a schematic diagram of a relationship between the polarization direction of the first polarizer, the polarization direction of the second polarizer, and the alignment direction of the first liquid crystal molecules of the display device. Referring to FIG. 3, the first direction may be the polarization direction of the first polarizer, the second direction may be the polarization direction of the second polarizer, and a third direction may be the alignment direction of the liquid crystal molecules. Therefore, on the basis of the above-disclosed embodiments, in one embodiment, when the display device is not powered on, the alignment direction of the first liquid crystal molecules 33 may form a first angle with the polarization direction of the first polarizer 31. The difference between the first angle and 45° may be within a preset angle, and the preset angle may be in a range approximately between 0°-10°. In other words, when the display device is not powered on, the angle between the alignment direction of the first liquid crystal molecules 33 and the polarization direction of the first polarizer 31 may be approximately 45°. It should be noted that the polarization directions of the first polarizer and the second polarizer may be parallel to the film layer where the first liquid crystal molecules are located, and the polarization direction of the first polarizer may be perpendicular to the polarization direction of the second polarizer. Therefore, when the display device is not powered on, the angle between the alignment direction of the first liquid crystal molecules and the polarization direction of the first polarizer may be approximately 45°, and the angle between the alignment direction of the first liquid crystal molecules and the polarization direction of the second polarizer may be approximately 45°.

In one embodiment, the first polarizer may be disposed on the light-incident side of the first liquid crystal molecules. When the display device is not powered on, the angle between the alignment direction of the first liquid crystal molecules and the polarization direction of the first polarizer may be approximately 45°, and the angle between the alignment direction of the first liquid crystal molecules and the polarization direction of the second polarizer may be approximately 45°. Therefore, the angle between the polarization direction of the first polarizer and the polarization direction of the second polarizer may be approximately 90°. When the display device is not powered on, the first liquid crystal molecules of the first liquid crystal panel may be aligned at 45°, which may be the maximum polarization angle of the matched first polarizer and second polarizer. Therefore, the light transmittance of the first liquid crystal panel may reach the maximum value, which may greatly reduce the power consumption of the display device in the high-brightness state.

On the basis of the above-disclosed embodiments, in one embodiment, referring to FIG. 4, the display component 10 may include the first liquid crystal panel 30. The first liquid crystal panel 30 may further include a first substrate 34 and a second substrate 35 that are disposed between the first polarizer 31 and the second polarizer 32. The first liquid crystal molecules 33 may be located between the first substrate 34 and the second substrate 35. In other words, in one embodiment, the display component may include the first liquid crystal panel. Therefore, when the display device is not powered on, the display component may have a substantially large light transmittance, which may greatly reduce the power consumption of the display device in the high-brightness state.

It should be noted that when the display device is not powered on, the angle between the alignment direction of the first liquid crystal molecules and each of the polarization direction of the first polarizer and the polarization direction of the second polarizer may be approximately 45°. In other words, the initial alignment direction of the first liquid crystal molecules may have a certain angle with each of the polarization direction of the first polarizer and the polarization direction of the second polarizer. In view of this, the light transmittance of the display component in the dark state may increase, which may affect the contrast ratio of the display device in the dark state. However, the display device in the disclosed embodiments may include the dimming component, and the dimming component may include a plurality of dimming regions. The light emitted from different dimming regions of the plurality of dimming regions may be adjusted independently, such that when the display device is in the dark state, the brightness of the light irradiated onto different regions of the first liquid crystal panel in the display component may be adjusted by adjusting the amount of light emitted from different dimming regions of the dimming component, thereby adjusting the light transmittance of the region of the display component corresponding to different dimming region. Therefore, when the display device is in the dark state, the contrast ratio of the display device in the dark state may be improved. Accordingly, the contrast ratio of the display device in the dark state may be desired while maintaining the low power consumption of the display device in the high-brightness state.

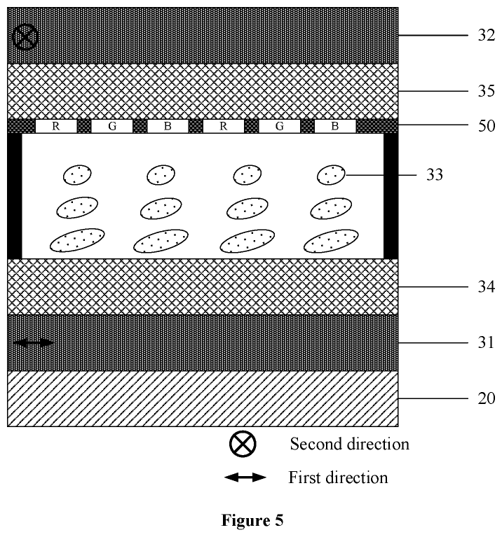

On the basis of the above-disclosed embodiments, in one embodiment, referring to FIG. 5, the display component may further include a color-resist layer 50. The color-resist layer 50 may be disposed between the first liquid crystal molecules 33 and the second substrate 35. The color-resist layer 50 may include a plurality of color blocks showing red, green, blue (RGB) three colors, such that the display component may display colors.

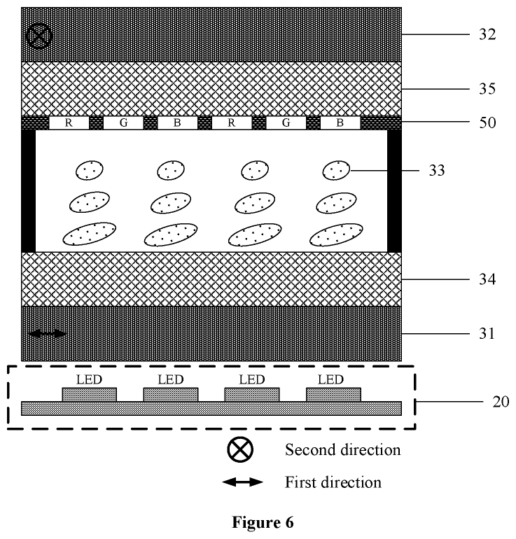

On the basis of the above-disclosed embodiments, in one embodiment, referring to FIG. 6, the dimming component 20 may include a plurality of LEDs that are arranged in an array. In other words, the light source of the display device may include LEDs arranged in an array. The display device may adopt a direct-type backlight source, such that the light source of the display device may have a substantially simple structure and a substantially thin thickness, thereby simplifying the structure of the display device and reducing the thickness of the display device. In addition, the display device may adopt a direct-type backlight source and may include a plurality of LEDs arranged in an array, such that the brightness of the backlight source may be substantially high.

On the basis of the above-disclosed embodiments, in one embodiment, the LED may include a miniLED, which may not be limited by the present disclosure and may be determined according to practical applications.

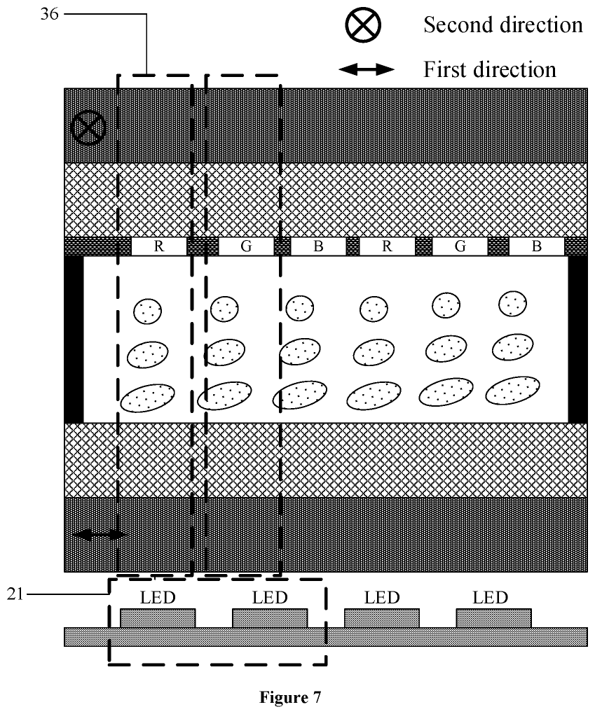

On the basis of the above-disclosed embodiments, in one embodiment, referring to FIG. 7, the first liquid crystal panel 30 may include a plurality of pixel regions 36. The dimming component 20 may include the plurality of dimming regions 21. One dimming region 21 may include at least one miniLED, and one dimming region 21 may correspond to N pixel regions 36, where N>Q, and Q is an integer greater than one. It should be noted that in one embodiment, the portion of the color-resist layer located in one pixel region may include a color block with one color. In certain embodiments, the portion of the color-resist layer located in one pixel region may include color blocks with the RGB three colors, which may be determined according to practical applications.

In one embodiment, the first liquid crystal panel may include the plurality of pixel regions, and one dimming region may correspond to N pixel regions. Therefore, when the display device is in a dark state, the amount of light emitted from different dimming regions may be adjusted to adjust the light transmittance of different pixel regions of the first liquid crystal panel. Specifically, by adjusting the luminance of the miniLEDs in different dimming regions, the light transmittance of the corresponding different pixel regions of the first liquid crystal panel may be adjusted, and then the contrast ratio of the display component in the dark state may be adjusted. Therefore, the impact on the contrast ratio of the display device in the dark state by the first angle between the alignment direction of the first liquid crystal molecules and the polarization direction of the first polarizer may be reduced to a certain extent.

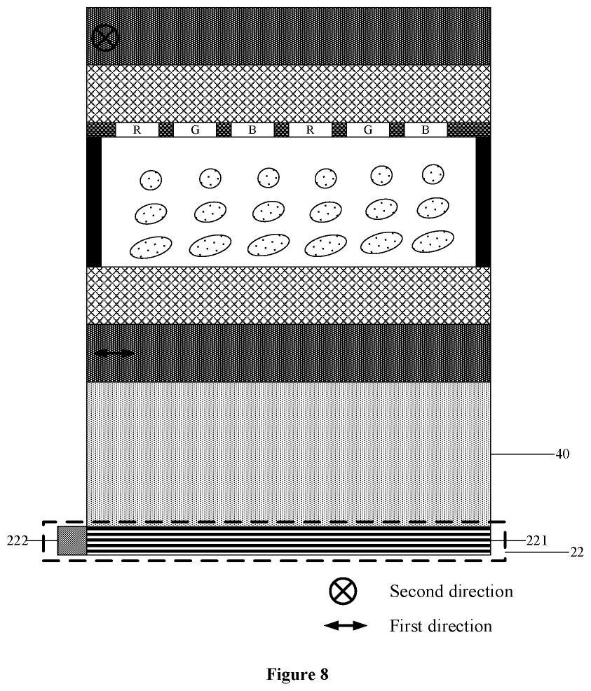

On the basis that the display component includes the first liquid crystal panel, in another embodiment, referring to FIG. 8, the dimming component 20 may include a backlight source 22 and a second liquid crystal panel 40 disposed on a light-emitting side of the backlight source 22. The backlight source 22 may include a light guide plate 221 and a light source 222 disposed on a side of the light guide plate 221. The second liquid crystal panel 40 may modulate the amount of light emitted from the backlight source 22.

Specifically, in one embodiment, the dimming component may include the backlight source, and the backlight source may include the light guide plate and the light source disposed on the side of the light guide plate. In other words, the dimming component may adopt a side-type backlight source. Compared with the direct-type backlight source, the side-type backlight source may merely need to install one light source on the side of the light guide plate, which is different from the direct-type backlight source that requires the plurality of LEDs arranged in an array as light source. Therefore, power consumption of the side-type backlight source may be substantially low, and power consumption of the dimming component may be substantially low, which may facilitate to reduce the power consumption of the display device.

Moreover, in one embodiment, the dimming component may further include the second liquid crystal panel, and the second liquid crystal panel may modulate the light emitted from the backlight source. Therefore, when the display device is in the dark state, the amount of light emitted from the light source may be adjusted, and then the brightness of the light emitted from the light source and irradiated on the second liquid crystal panel through the light guide plate may be adjusted, to adjust the light transmittance of the first liquid crystal panel, and to reduce the impact on the contrast ratio of the display device in the dark state by the initial alignment direction of 45° of the first liquid crystal molecules.

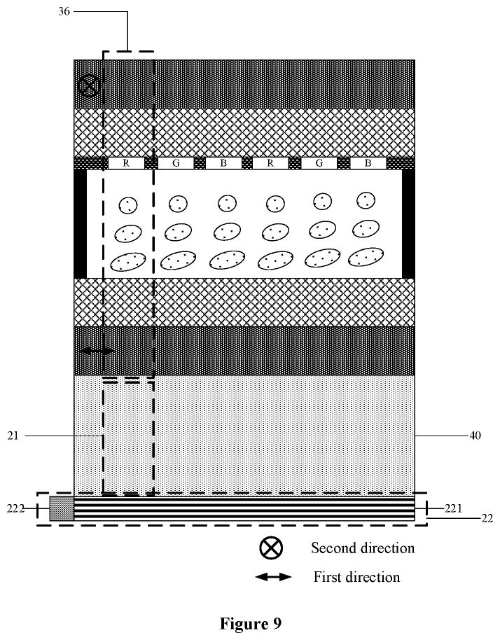

On the basis of the above-disclosed embodiments, in one embodiment, referring to FIG. 9, the first liquid crystal panel 30 may include the plurality of pixel regions 36, and the dimming component 20 may include the plurality of dimming regions 21. One dimming region 21 may correspond to M pixel regions, where M<Q, and Q is an integer greater than one. Compared with the dimming component in which the backlight source is a direct-type backlight source, the area of the dimming region 21 of the dimming component 20 may be smaller, and the adjustment precision of the dimming component may be higher, which may facilitate to reduce the influence on the contrast ratio of the display device in the dark state. It should be noted that in one embodiment, similar to the case where the dimming component adopts the direct-type backlight source, the portion of the color-resist layer located in one pixel region may include a color block with one color, or may include color blocks with RGB three colors, which may be determined according to practical applications.

It should be noted that the dimming component in the disclosed embodiments may include the second liquid crystal panel. By controlling the rotation direction of the liquid crystal molecules in different dimming regions of the second liquid crystal panel, the light irradiated on the first liquid crystal panel may be modulated, the dimming area may not be limited by the size of the light source of the backlight source, such that the area of the dimming region may be made substantially small.

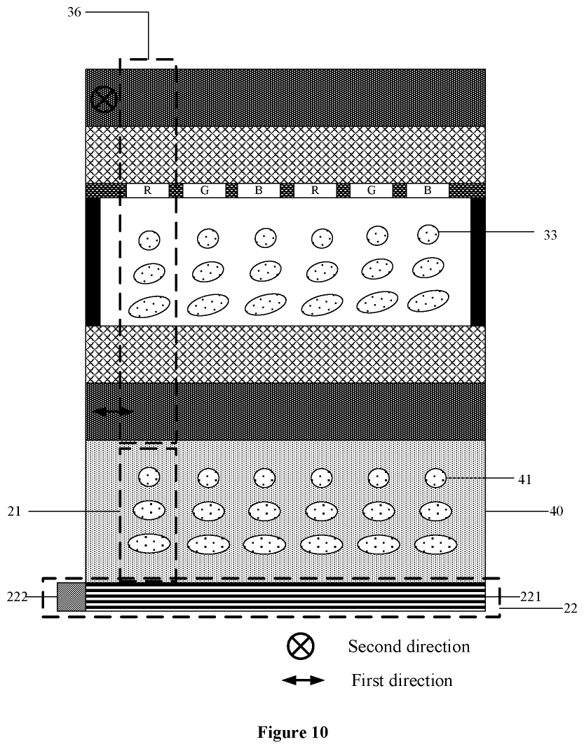

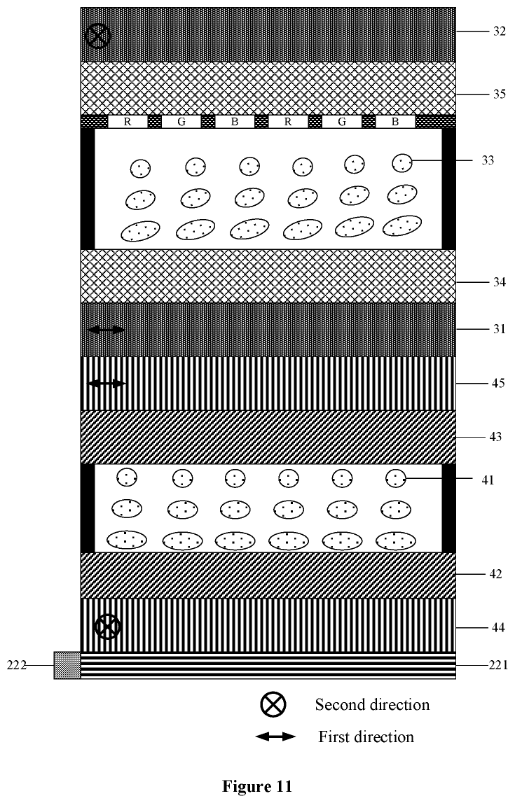

On the basis of the above-disclosed embodiments, in one embodiment, referring to FIG. 10, the second liquid crystal panel 40 may include second liquid crystal molecules 41. The alignment direction of the second liquid crystal molecules 41 may be different from the alignment direction of the first liquid crystal molecules 33.

On the basis of the above-disclosed embodiments, in one embodiment, referring to FIG. 11, the second liquid crystal panel 40 may include a third substrate 42 and a fourth substrate 43 that are oppositely disposed, a third polarizer 44 disposed on a side of the third substrate 42 away from the fourth substrate 43, and a fourth polarizer 45 disposed on a side of the fourth substrate 43 away from the third substrate 42. The second liquid crystal molecules 41 may be disposed between the third substrate 42 and the fourth substrate 43. The fourth polarizer 45 and the first polarizer 31 may be located between the second polarizer 32 and the third polarizer 44. The polarization direction of the fourth polarizer 45 may be the same as the polarization direction of the first polarizer 31, and the polarization direction of the second polarizer 32 may be the same as the polarization direction of the third polarizer 44.

Specifically, in one embodiment, the second liquid crystal panel may include second liquid crystal molecules. By adjusting the rotation direction of the second liquid crystal molecules in different dimming regions, the brightness of light emitted from different dimming regions in the dimming component may be adjusted. Further, the area of the dimming region of the dimming component may not be affected by the volume size of the light source, such that the area of the dimming region of the dimming component may be made substantially small, and the dimming precision of the dimming component may be substantially high, which may facilitate to reduce the impact on the contrast ratio of the display device in the dark state.

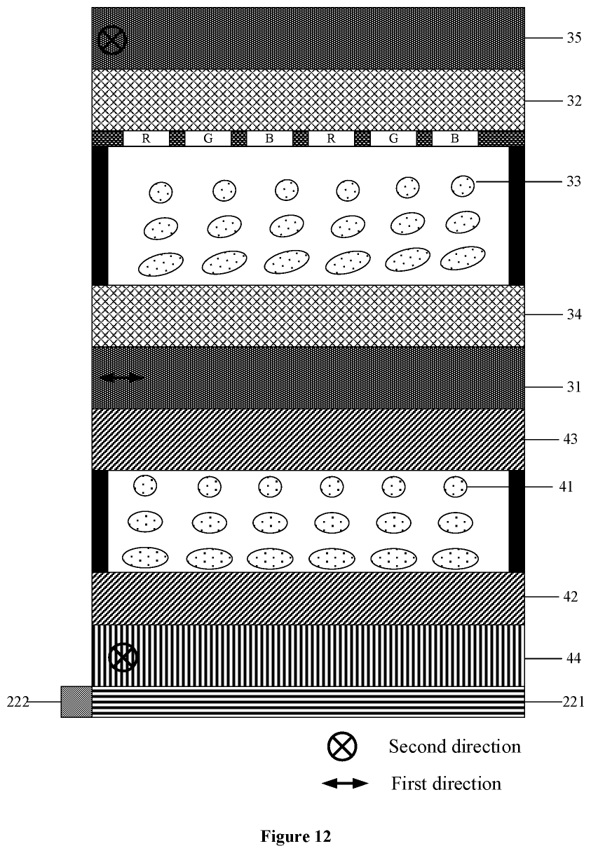

On the basis that the dimming component includes the second liquid crystal panel, and the second liquid crystal panel includes the second liquid crystal molecules, in another embodiment, referring to FIG. 12, the second liquid crystal panel 40 may include the third substrate 42 and the fourth substrate 43 that are oppositely disposed, and the third polarizer 44 disposed on the side of the third substrate 42 away from the fourth substrate 43. The second liquid crystal molecules 41 may be disposed between the third substrate 42 and the fourth substrate 43. The first polarizer 31 may be located between the second polarizer 32 and the third polarizer 44. The polarization direction of the second polarizer 32 may be the same as the polarization direction of the third polarizer 44.

Therefore, the second liquid crystal panel of the display device in the disclosed embodiment associated with FIG. 12 may include two substrates and one polarizer, while the display device in the above-disclosed embodiment associated with FIG. 11 may include two substrates and two polarizers. Compared with the above embodiment associated with FIG. 11, the display device in the disclosed embodiment associated with FIG. 12 may have one less polarizer. Moreover, the display device in the disclosed embodiment associated with FIG. 12 may also adjust the brightness of light emitted from the dimming region by adjusting the rotation direction of the second liquid crystal panel, thereby achieving the purpose of adjusting the light transmittance of the first liquid crystal panel. Compared with the embodiment associated with FIG. 11, the cost of the display device in the embodiment associated with FIG. 12 may be substantially low.

On the basis of the two above-disclosed embodiments, in one embodiment, the angle between the alignment direction of the second liquid crystal molecules and the polarization direction of the third polarizer may refer to a second angle. The second liquid crystal molecules may be aligned at 0°, and the difference between the second angle and 0° may be in a range approximately between 0°-10°. In another embodiment, the second liquid crystal molecules may be aligned at 90°, and the difference between the second angle and 90° may be in a range approximately between 0°-10°.

In other words, the display device in the disclosed embodiments may have two structures. First, for the display component, when the display device is not powered on, the first liquid crystal molecules in the first liquid crystal panel may be aligned at 45°, and the angle between the alignment direction of the first liquid crystal molecules and the polarization direction of the first polarizer may be approximately 45°. For the dimming component, the second liquid crystal molecules in the second liquid crystal panel may be aligned at 0°, and the angle between the alignment direction of the second liquid crystal molecules and the polarization direction of the third polarizer may be approximately 0°. Second, for the display component, when the display device is not powered on, the first liquid crystal molecules in the first liquid crystal panel may be aligned at 45°, and the angle between the alignment direction of the first liquid crystal molecules and the polarization direction of the first polarizer may be approximately 45°. The second liquid crystal molecules in the second liquid crystal panel may be aligned at 90°, and the angle between the alignment direction of the second liquid crystal molecules and the polarization direction of the third polarizer may be approximately 90°. Accordingly, in the disclosed display device, the liquid crystal molecules in the display component may be initially aligned at 45°, and the liquid crystal molecules in the dimming component may be aligned at 0° or 90°.

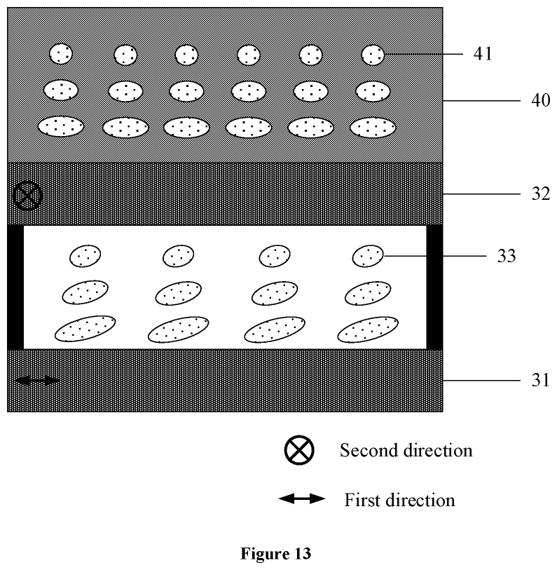

The above-disclosed embodiments may describe a case that the display component in the display device may include the first liquid crystal panel. In another embodiment, the dimming component in the disclosed display device may include the first liquid crystal panel. Therefore, in certain embodiments, referring to FIG. 13, the dimming component 20 may include the first liquid crystal panel 30, and the display component 10 may include the second liquid crystal panel 40. The second liquid crystal panel 40 may include the second liquid crystal molecules 41. The alignment direction of the first liquid crystal molecules 33 in the first liquid crystal panel 30 may be different from the alignment direction of the second liquid crystal molecules 41 in the second liquid crystal panel 40.

Specifically, in one embodiment, the first liquid crystal molecules in the first liquid crystal panel may be aligned at 45°, and the polarization directions of the first polarizer and the second polarizer may be perpendicular to each other. Therefore, when the display device is not powered on, the light transmittance of the first liquid crystal panel may reach the maximum. In other words, when the display device is not powered on, the light transmittance of the dimming component may be substantially large, such that the power consumption of the display device in the high-brightness state may be substantially low, which may greatly reduce the power consumption of the display device in the high-brightness state.

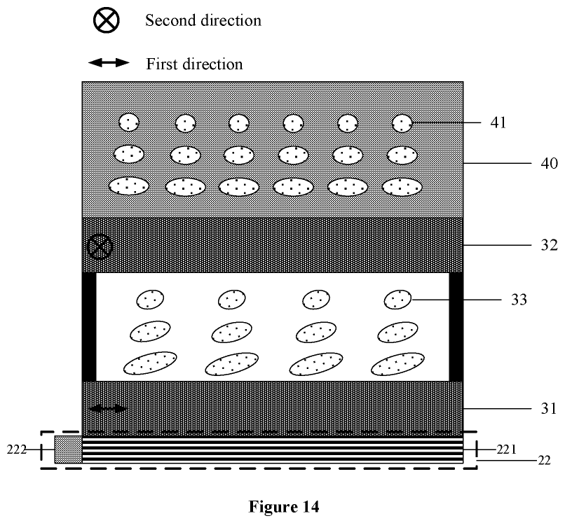

On the basis of the above-disclosed embodiments, in one embodiment, referring to FIG. 14, the dimming component 20 may include the backlight source 22, and the backlight source 22 may be disposed on a side of the first liquid crystal panel 30 away from the display component 10. The backlight source 22 may include the light guide plate 221 and the light source 222 located on the side of the light guide plate 221. The first liquid crystal panel 30 may modulate the light emitted from the backlight source 22.

Specifically, by adjusting the rotation direction of the first liquid crystal molecules in different dimming regions of the first liquid crystal panel, the brightness of the light irradiated on the display component through the first liquid crystal panel may be adjusted. Therefore, when the display device is in the dark state, the light transmittance of different pixel regions of the display component may be adjusted to ensure the contrast ratio of the display device in the dark state. It should be noted that the first liquid crystal molecules may be aligned at 45°, which may lead to a maximum light transmittance to make the display device in the high-brightness state. When the display device is in the dark state, it is not necessary to ensure that the light transmittance of the first liquid crystal panel is the maximum, in other words, it is not necessary to maintain that the first liquid crystal molecules are aligned at 45°. Therefore, when the display device is in the dark state, by adjusting the alignment direction of the first liquid crystal molecules, the contrast ratio of the display device in the dark state may be guaranteed.

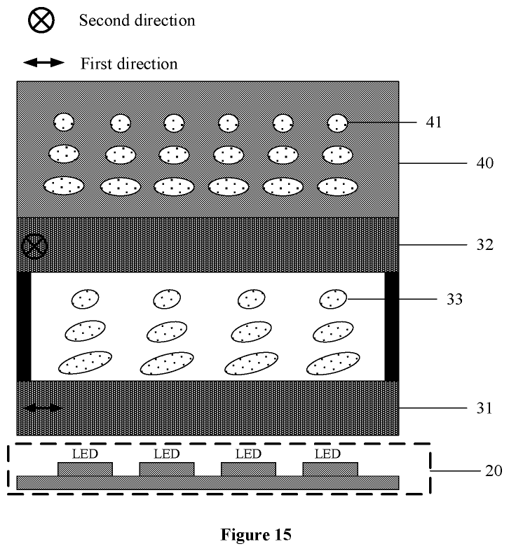

On the basis that the dimming component includes the first liquid crystal panel, in another embodiment, referring to FIG. 15, the dimming component 20 may include a plurality of LEDs arranged in an array. In other words, the dimming component 20 may adopt a direct-type backlight source. In one embodiment, the plurality of LEDs arranged in an array may include miniLED.

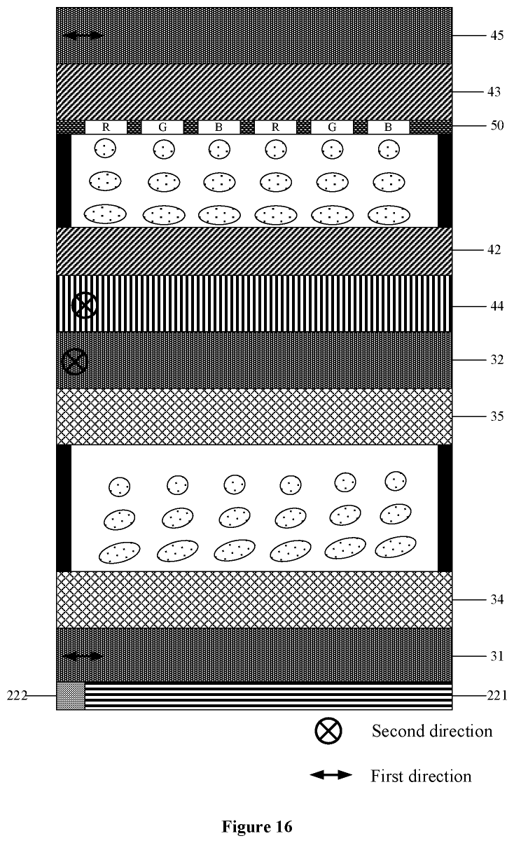

On the basis of the above-disclosed embodiments, in one embodiment, referring to FIG. 16, the first liquid crystal panel 30 may further include the first substrate 34 and the second substrate 35 that are disposed between the first polarizer 31 and the second polarizer 32. The first liquid crystal molecules 33 may be located between the first substrate 34 and the second substrate 35. The second liquid crystal panel 40 may include the third substrate 42 and the fourth substrate 43 that are oppositely disposed, the third polarizer 44 disposed on the side of the third substrate 42 away from the fourth substrate 43, and the fourth polarizer 45 disposed on the side of the fourth substrate 43 away from the third substrate 42. The second liquid crystal molecules 41 may be located between the third substrate 42 and the fourth substrate 43. The third polarizer 44 and the second polarizer 32 may be located between the fourth polarizer 45 and the first polarizer 31. The polarization direction of the fourth polarizer 45 may be the same as the polarization direction of the first polarizer 31, and the polarization direction of the second polarizer 32 may be the same as the polarization direction of the third polarizer 44.

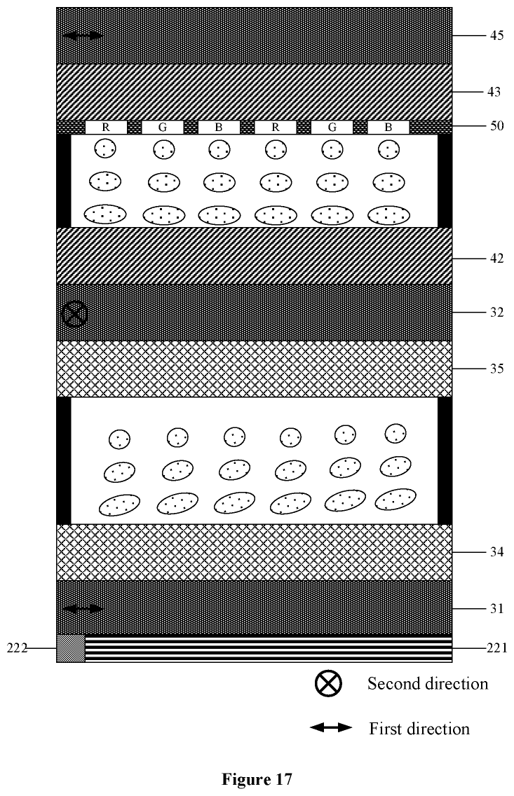

In another embodiment, referring to FIG. 17, the first liquid crystal panel 30 may further include the first substrate 34 and the second substrate 35 that are disposed between the first polarizer 31 and the second polarizer 32. The first liquid crystal molecules 33 may be located between the first substrate 34 and the second substrate 35. The second liquid crystal panel 40 may include the third substrate 42 and the fourth substrate 43 that are oppositely disposed, and the fourth polarizer 45 disposed on the side of the fourth substrate 43 away from the third substrate 42. The second liquid crystal molecules 41 may be located between the third substrate 42 and the fourth substrate 43. The second polarizer 32 may be located between the first polarizer 31 and the fourth polarizer 45. The polarization direction of the fourth polarizer 45 may be the same as the polarization direction of the first polarizer 31. Compared with the above embodiment associated with FIG. 16, the display device in the disclosed embodiment associated with FIG. 17 may have one less polarizer. Therefore, compared with the embodiment associated with FIG. 16, the cost of the display device in the embodiment associated with FIG. 17 may be substantially low.

On the basis of the two above-disclosed embodiments, in one embodiment, the angle between the alignment direction of the second liquid crystal molecules and the polarization direction of the third polarizer may refer to the second angle. The second liquid crystal molecules may be aligned at 0°, and the difference between the second angle and 0° may be in a range approximately between 0°-10°. In another embodiment, the second liquid crystal molecules may be aligned at 90°, and the difference between the second angle and 90° may be in a range approximately between 0°-10°. In other words, in the disclosed display device, the liquid crystal molecules in the display component may be aligned at 0° or 90°, and the liquid crystal molecules in the dimming component may be aligned at 45°. Therefore, the manufacturing process of the disclosed display device may be compatible with the manufacturing process of the existing display device, thereby reducing the manufacturing cost of the display device.

On the basis of the above-disclosed embodiments, in one embodiment, referring to FIG. 16 and FIG. 17, the second liquid crystal panel may further include the color-resist layer 50. The color-resist layer 50 may be disposed between the second liquid crystal molecules and the fourth substrate 43. The color-resist layer 50 may include a plurality of color blocks showing red, green, blue (RGB) three colors, such that the display component may display colors.

In the above-disclosed embodiments, the alignment direction of the liquid crystal molecules in the display component may be different from the alignment direction of the liquid crystal molecules in the dimming component, which may not be limited by the present disclosure. In certain embodiments, the alignment direction of the liquid crystal molecules in the display component may be the same as the alignment direction of the liquid crystal molecules in the dimming component. Specifically, the display component may include the first liquid crystal panel, and the dimming component may include the second liquid crystal panel. The first liquid crystal panel may include the first liquid crystal molecules, and the second liquid crystal panel may include the second liquid crystal molecules. The alignment direction of the first liquid crystal molecules in the first liquid crystal panel may be the same as the alignment direction of the second liquid crystal molecules in the second liquid crystal panel.

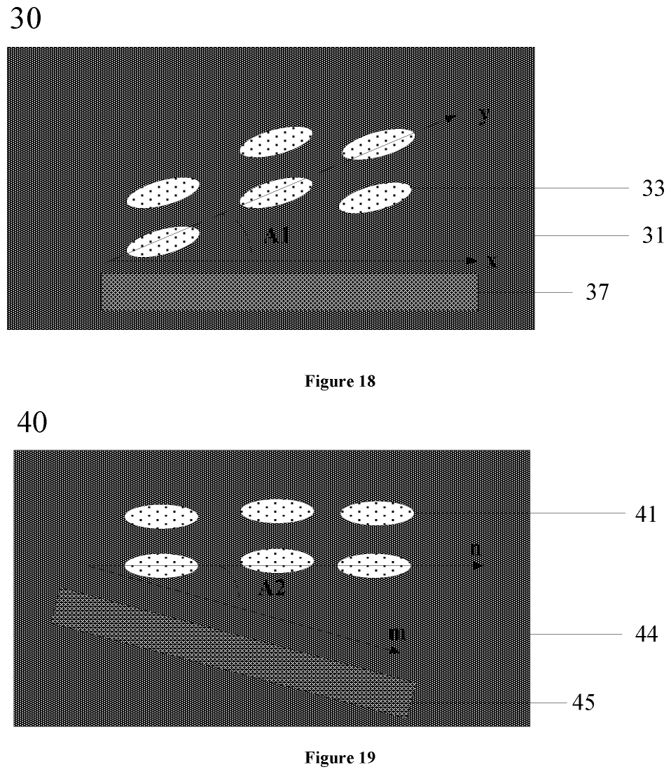

On the basis of any one of the above-disclosed embodiments, in one embodiment, referring to FIG. 18, the first liquid crystal panel 30 may include a pixel electrode 37 disposed between the first liquid crystal molecules 33 and the first polarizer 31. An electrode extension direction x of the pixel electrode 37 may be parallel to the plane where the first polarizer 31 is located, and may form a third angle A1 with the alignment direction y of the first liquid crystal molecules 33. The third angle A1 may be in a range approximately between 3-20° or 70°-87°. Specifically, when the first liquid crystal molecules are positive liquid crystals, the angle between the electrode extension direction of the pixel electrode and the alignment direction of the first liquid crystal molecules 33 may be in a range approximately between 3-20°. When the first liquid crystal molecules are negative liquid crystals, the angle between the electrode extension direction of the pixel electrode and the alignment direction of the first liquid crystal molecules may be in a range approximately between 70°-87°. Therefore, the pixel electrode may transmit signals to the first liquid crystal molecules on the premise of without affecting the operation of the first liquid crystal molecules.

On the basis of the above-disclosed embodiments, in one embodiment, referring to FIG. 19, the second liquid crystal panel 40 may include a pixel electrode 45 disposed between the second liquid crystal molecules 41 and the third polarizer 44. An electrode extension direction of the pixel electrode 45 may be parallel to the plane where the third polarizer 44 is located. An angle between the electrode extension direction m and the alignment direction n of the second liquid crystal molecules 41 may refer to a fourth angle A2. The fourth angle A2 may be in a range approximately between 3°-20° or 70°-87°. Specifically, when the second liquid crystal molecules are positive liquid crystals, the angle between the electrode extension direction of the pixel electrode and the alignment direction of the second liquid crystal molecules may be in a range approximately between 3°-20°. When the second liquid crystal molecules are negative liquid crystals, the angle between the electrode extension direction of the pixel electrode and the alignment direction of the second liquid crystal molecules may be in a range approximately between 70°-87°. Therefore, the pixel electrode may transmit signals to the second liquid crystal molecules on the premise of without affecting the operation of the second liquid crystal molecules.

Accordingly, the present disclosure provides a display device. The display device may include a display component and a dimming component disposed on a non-display side of the display component. The dimming component may include a plurality of dimming regions, and the light emitted from different dimming regions may be adjusted independently. The display component or the dimming component may include a first liquid crystal panel. The first liquid crystal panel may include a first polarizer and a second polarizer that are oppositely disposed, and first liquid crystal molecules located between the first polarizer and the second polarizer. The polarization directions of the first polarizer and the second polarizer may be perpendicular to each other. When the display device is not powered on, the first liquid crystal molecules may be aligned at 45°, which may be the maximum polarization angle of the matched first polarizer and second polarizer. Therefore, when the display device is not powered on, the light transmittance of the first liquid crystal panel may reach the maximum value, which may greatly reduce the power consumption of the display device in the high-brightness state.

The disclosed display device may have following beneficial effects. The display component or the dimming component in the display device may include the first liquid crystal panel. The first liquid crystal panel may include the first polarizer, the second polarizer, and the first liquid crystal molecules disposed between the first polarizer and the second polarizer. The polarization direction of the first polarizer may be perpendicular to the polarization direction of the second polarizer, and the first liquid crystal molecules may be aligned at 45° when the display device is not powered on. Therefore, when the display device in the disclosed embodiments is not powered on, in other words, in the initial alignment state of the liquid crystal molecules, the first liquid crystal molecules of the first liquid crystal panel may be aligned at 45°, which may be the maximum polarization angle of the matched first polarizer and second polarizer. When the display device is in operation, the light irradiated on the first liquid crystal molecules through the lower polarizer may be sufficiently rotated to the upper polarizer through the first liquid crystal molecules. Therefore, when the display device is not powered on, the light transmittance of the first liquid crystal panel may reach the maximum value, which may greatly reduce the power consumption of the display device in the high-brightness state.

Various embodiments in the present specification are described in a progressive, parallel, or progressive and parallel manner. Each embodiment mainly describes in terms of differences from other embodiments, and the same or similar parts between various embodiments may be referred to each other.

It should be noted that the orientation or positional relationship indicated by the terms “upper”, “lower”, “top”, “bottom”, “inner” and “outer” are based on the orientation or positional relationship shown in the drawings, which is only for the convenience of describing the present disclosure and simplifying the description, and does not indicate or imply that the referred device or component must have a specific orientation, be constructed and operated in a specific orientation, and therefore cannot be understood as limitations on the present disclosure. When a component is considered to be “connected” to another component, the component may be directly connected to the another component, or there may be a component disposed therebetween.

It should be noted that the relational terms such as “first” and “second” are merely used to distinguish one entity or operation from another entity or operation, and do not necessarily require or imply any such actual relationship or sequence between these entities or operations. Moreover, the terms “include”, “contain” or any variant may be intended to cover non-exclusive inclusion, such that a process, a method, an article, or a device that includes a series of elements may not only include such elements, but also include any other element that is not clearly listed, or may include elements inherent to such process, method, article or device. In a case without more restrictions, the element defined by the sentence “including . . . ” may not exclude the existence of any other same element in the process, method, article, or device that includes the element.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments illustrated herein but is to be accorded the widest scope consistent with the principles and novel features disclosed herein.

1. A display device, comprising:
a display component and a dimming component, wherein:
the dimming component is disposed on a non-display side of the display component, and provides backlight for the display component,
the dimming component includes a plurality of dimming regions, and light emitted from different dimming regions of the plurality of dimming regions is adjusted independently,
one of the display component and the dimming component includes a first liquid crystal panel, and the first liquid crystal panel includes a first polarizer and a second polarizer that are oppositely disposed, and first liquid crystal molecules located between the first polarizer and the second polarizer, and
a polarization direction of the first polarizer is perpendicular to a polarization direction of the second polarizer, and when the display device is not powered on, all the first liquid crystal molecules located between the first polarizer and the second polarizer are aligned at approximately 45° with each of the polarization direction of the first polarizer and the polarization direction of the second polarizer.

2. The display device according to claim 1, wherein:
when the display device is not powered on, an alignment direction of the first liquid crystal molecules forms a first angle with the polarization direction of the first polarizer, and
a difference between the first angle and 45° is within a preset angle, and the preset angle is in a range approximately between 0°-10°.

3. The display device according to claim 2, wherein:
the display component includes the first liquid crystal panel, and
the first liquid crystal panel further includes a first substrate and a second substrate that are disposed between the first polarizer and the second polarizer, and the first liquid crystal molecules are located between the first substrate and the second substrate.

4. The display device according to claim 3, wherein:
the dimming component includes a plurality of LEDs that are arranged in an array.

5. The display device according to claim 4, wherein:
a LED of the plurality of LEDs includes a miniLED.

6. The display device according to claim 4, wherein:
the first liquid crystal panel includes a plurality of pixel regions, and
the dimming component includes the plurality of dimming regions, and one dimming region of the plurality of dimming regions corresponds to N pixel regions of the plurality of pixel regions, wherein N>Q, and Q is an integer greater than one.

7. The display device according to claim 3, wherein:
the dimming component includes a backlight source and a second liquid crystal panel disposed on a light-emitting side of the backlight source, wherein the backlight source includes a light guide plate and a light source disposed on a side of the light guide plate, and the second liquid crystal panel modulates light emitted from the backlight source.

8. The display device according to claim 7, wherein:
the first liquid crystal panel includes a plurality of pixel regions, and
the dimming component includes the plurality of dimming regions, and one dimming region of the plurality of dimming regions corresponds to M pixel regions, wherein M<Q, and Q is an integer greater than one.

9. The display device according to claim 7, wherein:
the second liquid crystal panel includes second liquid crystal molecules, and an alignment direction of the second liquid crystal molecules in the second liquid crystal panel is different from the alignment direction of the first liquid crystal molecules in the first liquid crystal panel.

10. The display device according to claim 9, wherein:
the second liquid crystal panel includes a third substrate and a fourth substrate that are oppositely disposed, a third polarizer disposed on a side of the third substrate away from the fourth substrate, and a fourth polarizer disposed on a side of the fourth substrate away from the third substrate,
the second liquid crystal molecules are disposed between the third substrate and the fourth substrate,
the fourth polarizer and the first polarizer are located between the second polarizer and the third polarizer, and
a polarization direction of the fourth polarizer is the same as the polarization direction of the first polarizer, and the polarization direction of the second polarizer is the same as a polarization direction of the third polarizer.

11. The display device according to claim 9, wherein:
the second liquid crystal panel includes a third substrate and a fourth substrate that are oppositely disposed, and a third polarizer disposed on a side of the third substrate away from the fourth substrate,
the second liquid crystal molecules are disposed between the third substrate and the fourth substrate,
the first polarizer is located between the second polarizer and the third polarizer, and
the polarization direction of the second polarizer is the same as a polarization direction of the third polarizer.

12. The display device according to claim 10, wherein:
the alignment direction of the second liquid crystal molecules forms a second angle with the polarization direction of the third polarizer, and
the second liquid crystal molecules are aligned at 0°, and a difference between the second angle and 0° is in a range approximately between 0°-10°, or
the second liquid crystal molecules are aligned at 90°, and a difference between the second angle and 90° is in a range approximately between 0°-10°.

13. The display device according to claim 1, wherein:
the dimming component includes the first liquid crystal panel, and the display component includes a second liquid crystal panel, and
the second liquid crystal panel includes second liquid crystal molecules, and an alignment direction of the first liquid crystal molecules in the first liquid crystal panel is different from an alignment direction of the second liquid crystal molecules in the second liquid crystal panel.

14. The display device according to claim 13, wherein:
the dimming component includes a backlight source,
the backlight source is disposed on a side of the first liquid crystal panel away from the display component, and includes a light guide plate and a light source located on a side of the light guide plate, and
the first liquid crystal panel modulates light emitted from the backlight source.

15. The display device according to claim 14, wherein:
the first liquid crystal panel further includes a first substrate and a second substrate that are disposed between the first polarizer and the second polarizer, and the first liquid crystal molecules are located between the first substrate and the second substrate;
the second liquid crystal panel includes a third substrate and a fourth substrate that are oppositely disposed, a third polarizer disposed on a side of the third substrate away from the fourth substrate, and a fourth polarizer disposed on a side of the fourth substrate away from the third substrate,
the alignment direction of the second liquid crystal molecules forms a second angle with a polarization direction of the third polarizer, and
the second liquid crystal molecules are aligned at 0°, and a difference between the second angle and 0° is in a range approximately between 0°-10°, or
the second liquid crystal molecules are aligned at 90°, and a difference between the second angle and 90° is in a range approximately between 0°-10°; and
the second polarizer and the third polarizer are located between the first polarizer and the fourth polarizer, and
the polarization direction of the first polarizer is the same as a polarization direction of the fourth polarizer, and the polarization direction of the second polarizer is the same as the polarization direction of the third polarizer.

16. The display device according to claim 14, wherein:
the first liquid crystal panel further includes a first substrate and a second substrate that are disposed between the first polarizer and the second polarizer, and the first liquid crystal molecules are located between the first substrate and the second substrate;
the second liquid crystal panel includes a third substrate and a fourth substrate that are oppositely disposed, a fourth polarizer disposed on a side of the fourth substrate away from the third substrate, and a color-resist layer and the second liquid crystal molecules located between the third substrate and the fourth substrate,
the alignment direction of the second liquid crystal molecules forms a second angle with a polarization direction of the fourth polarizer, and
the second liquid crystal molecules are aligned at 0°, and a difference between the second angle and 0° is in a range approximately between 0°-10°, or
the second liquid crystal molecules are aligned at 90°, and a difference between the second angle and 90° is in a range approximately between 0°-10°; and
the second polarizer is located between the first polarizer and the fourth polarizer, and the polarization direction of the first polarizer is the same as the polarization direction of the fourth polarizer.

17. The display device according to claim 1, wherein:
the display component includes the first liquid crystal panel, and the dimming component includes a second liquid crystal panel,
the first liquid crystal panel includes the first liquid crystal molecules, and the second liquid crystal panel includes second liquid crystal molecules, and
an alignment direction of the first liquid crystal molecules in the first liquid crystal panel is the same as an alignment direction of the second liquid crystal molecules in the second liquid crystal panel.

18. The display device according to claim 1, wherein:
the first liquid crystal panel includes a pixel electrode disposed between the first liquid crystal molecules and the first polarizer, and
an electrode extension direction of the pixel electrode forms a third angle with an alignment direction of the first liquid crystal molecules, wherein the third angle is in a range approximately between 3°-20° or 70°-87°.

19. (canceled)

20. The display device according to claim 16, wherein:
the color-resist layer includes a plurality of color blocks showing red, green, and blue colors.
